(19) United States
(12) Patent Application Publication
(10) Pub. No.: US 2011/0187503 A1
(43) Pub. Date: Aug. 4, 2011

(54) Method and System for Data Center Rack Brackets For Automatic Location Tracking of Information Technology Components

(76) Inventors: Mario Costa, Davie, FL (US); Steven Geffin, N. Miami Beach, FL (US)

(21) Appl. No.: 12/697,511

(22) Filed: Feb. 1, 2010

(51) Int. Cl. G08B 5/22; G06F 17/30

(52) U.S. Cl. 340/8.1; 707/E17.005

(57) ABSTRACT

Methods and systems provide the automatic tracking of the physical location of information technology components in a data center. These systems automatically identify where a given IT component, such as a server, router, switch or other device, is located. They automatically identify which slot the IT component is located in a given rack in the data center. They include “smart” brackets containing small ID chips attached to the rack-based IT components and a “smart” rack rail for detecting the brackets. Each smart bracket uniquely identifies the IT component to which it is attached. The smart rack rail identifies the slot of the rack in which the IT component resides and communicates with a microcontroller to relay the position information to a database.

### FIELD OF THE INVENTION

This generally relates to information technology components in a data center, and more particularly to automatic location tracking of information technology components, such as servers, routers and switches, in a data center.

### BACKGROUND

Data centers are buildings or rooms that house large numbers of information technology components such as computing equipment (e.g., servers, data processors, appliances), storage networking equipment (e.g., switches, routers, patch panels) and power equipment (e.g., UPS, power strips) or other computer components. Typically, the interior of a data center is filled with multiple rows of cabinet-like equipment called racks that are arranged in parallel to one another throughout the data center. Each rack houses multiple, vertically spaced components, and an aisle for service personnel is often provided between rows of racks. In this way, a large number of servers or other components can be placed in a data center. Alternatively, these components are also stored in computer rooms, IT equipment closets or other suitable environments.

The individual information technology (IT) components mounted inside the racks are supplied power by power distribution units (PDU) that typically mount to the rear columns of the rack. A standard rack typically includes front-mounting rails to which multiple units of equipment, such as servers and CPUs, are mounted and stacked vertically within the rack. The components stacked in a rack are each housed in a slot, and a rack may have many slots. A standard rack at any given time can be sparsely or densely populated with a variety of different IT components. Also, a single IT component may occupy more than one slot.

When tracking these IT components, data center technicians need to be sure of the existence and location of them. Sometimes during maintenance, data center technicians can add, change or remove an IT component, or move the component elsewhere within the data center. In these cases, if the database for tracking the location of these components is not updated, conventionally a manual process, the database will be outdated and contain inaccurate information. Furthermore, in many cases, manual record keeping is used instead of a database. A technician's reliance on this incorrect information can be greatly detrimental. For example, if a technician desires to locate a particular target component, the component may not be where the database or records indicate it is, or may not be part of the data center anymore. When planning a data center, the placement of components in various slots on racks throughout the data center takes careful planning and consideration of various factors such as power supply, ventilation, heating and cooling. These factors may change from time to time. For example, it may be desirable to move components in a rack due to a change in power conditions.

Many organizations use enterprise asset management solutions to help manage their valuable IT assets, but find that updating asset information, such as their physical location, still requires extensive manual effort. If an IT component is not properly accounted for, it is no longer visible, and increases the risk of underutilization of the component, or it being lost or stolen.

Conventional systems address physical asset management at the data center room level, or rely heavily on manual processes and periodic manual audits for information updates regarding the physical location of these components in the data center. Manual audits are an expensive and time-consuming process, and manually managing these assets significantly adds to IT costs. These systems do not give the users an automatic, instantaneous and cost effective way of knowing where a given IT component is located at any point in time within the data center. They do not provide a way for users to automatically have up-to-date physical location information for where an IT component is within a given data center room, on which rack they it resides, or in which slot within a rack.

Any changes in the infrastructure such as removing or changing the location of an IT component are not detected immediately by conventional systems. In these systems, technicians are relied upon to notify the changes through proper communications, and a person manually updates the database. These processes are often violated through human error, leaving the database with incorrect information. As a result, conventional systems do not allow users to be sure that when remotely managing location information of a given server or device the right server or device will be managed.

Some conventional RFID systems do not provide a cost-effective way of identifying IT components down to the slot-level in a rack.

Accordingly, there is a desire to address problems associated with of the management of location information of the physical location of IT components in a data center. It is desirable to have methods and systems to avoid these and other related problems.

### SUMMARY

In accordance with methods and systems consistent with the present invention, a method is provided in a data processing system for automatically tracking locations of IT components in a data center, comprising attaching a bracket comprising an ID chip uniquely identifying the bracket to an IT component, and associating the bracket with the attached IT component. The method further comprises inserting the IT component into a slot in a rack, the slot comprising one or more contacts configured to connect to the ID chip on the bracket, automatically determining a presence of the bracket in the rack based on the ID chip, and automatically determining a position of the bracket in the slot in the rack.

In accordance with an implementation, a data processing system is provided for automatically tracking locations of IT components in a data center, comprising a bracket configured to attach to an IT component and comprising an ID chip uniquely identifying the IT component. The data processing system further comprises a rack comprising one or more slots, the slots configured to store an IT component and comprising one or more contacts configured to connect to the ID chip on the bracket. Furthermore, the data processing system comprises a microcontroller configured to determine a presence of the bracket and a position of the bracket in one of the slots when inserted into the slot, and transmit information regarding the presence of the bracket and position of the bracket to a database.

In another implementation, a data processing system is provided for automatically tracking locations of IT components in a data center, comprising a bracket configured to attach to an IT component and comprising an ID chip uniquely identifying the IT component, and a rack comprising one or more slots, the slots configured to store an IT component and comprising one or more contacts configured to connect to the ID chip on the bracket wherein the slot includes a capacitor having a charge time uniquely identifying the slot. The data processing system further comprises a microcontroller configured to determine a presence of the bracket in the rack, determine a position of the bracket in one of the slots by charging the capacitor and measuring the charge time to uniquely identify the slot in which the capacitor is located, and transmit information regarding the presence of the bracket and position of the bracket to a database. The database is configured to store identification and location information of IT components in the data center, and update upon receipt of the information regarding the presence of the bracket and position of the bracket.

### BRIEF DESCRIPTION OF THE DRAWINGS

FIG. 1 depicts a rack with two smart rails storing a server in accordance with methods and systems consistent with the present invention.

FIG. 2 illustrates a smart rack rail and a smart bracket.

FIG. 3 illustrates a diagram of a smart bracket in accordance with methods and system consistent with the present invention.

FIG. 4 illustrates a circuit diagram of a smart rail having Id pads, position pads and a microcontroller in accordance with methods and system consistent with the present invention.

FIG. 5 depicts steps of a method for adding new IT components to a rack in accordance with methods and systems consistent with the present invention.

FIG. 6 depicts steps of a method for removing IT components from a rack in accordance with methods and systems consistent with the present invention.

FIG. 7 depicts steps of a method for moving IT components in a rack in accordance with methods and systems consistent with the present invention.

### DETAILED DESCRIPTION

Methods and systems in accordance with the present invention provide the automatic tracking and management of the physical location of information technology components in a data center. These methods and systems automatically identify where a given IT component, such as a server, router, switch or other device, is located. In particular, they automatically identify which slot the IT component is located in a given rack in the data center. When a server, for example, is added or removed from a particular slot, the tracking database is automatically notified and updated, and users of the database have instantaneously accurate information about the location of each IT component in a data center. If the server is changed to a different slot or rack, the system immediately identifies that the given server or device is located in a different location. Users can confidently rely on the information in the database when remotely managing the data center's IT assets. These systems allow users to be sure that, when remotely managing a given server or device, the physical location of the server or device will be known down to the slot level. For example, these systems may automatically update a database with IT component data and timing of movements of IT components. This also avoids the need for costly manual audits of IT components in a data center.

Most equipment used in today's data centers such as servers, routers, UPS and rack managers are typically installed in racks or equipment cabinets. Depending on their size and type, typical racks used in data centers hold 1 to 48 separate IT components. Two brackets (one on each side of the equipment) are used to mount the IT components in the racks.

Methods and systems in accordance with the present invention identify which IT components are installed in each rack and in which slot the IT component is installed. Insertion and removal of an asset is automatically detected and communicated to the proper software layer responsible for asset management. In one implementation, methods and systems in accordance with the present invention include “smart” brackets containing small identification (“ID”) chips that are attached to the rack-based IT components and a “smart” rack rail. In one implementation, each smart bracket uniquely identifies the IT component to which it is attached. The smart rack rail identifies the slot of the rack in which the IT component resides and communicates with a microcontroller to relay the position information to a database.

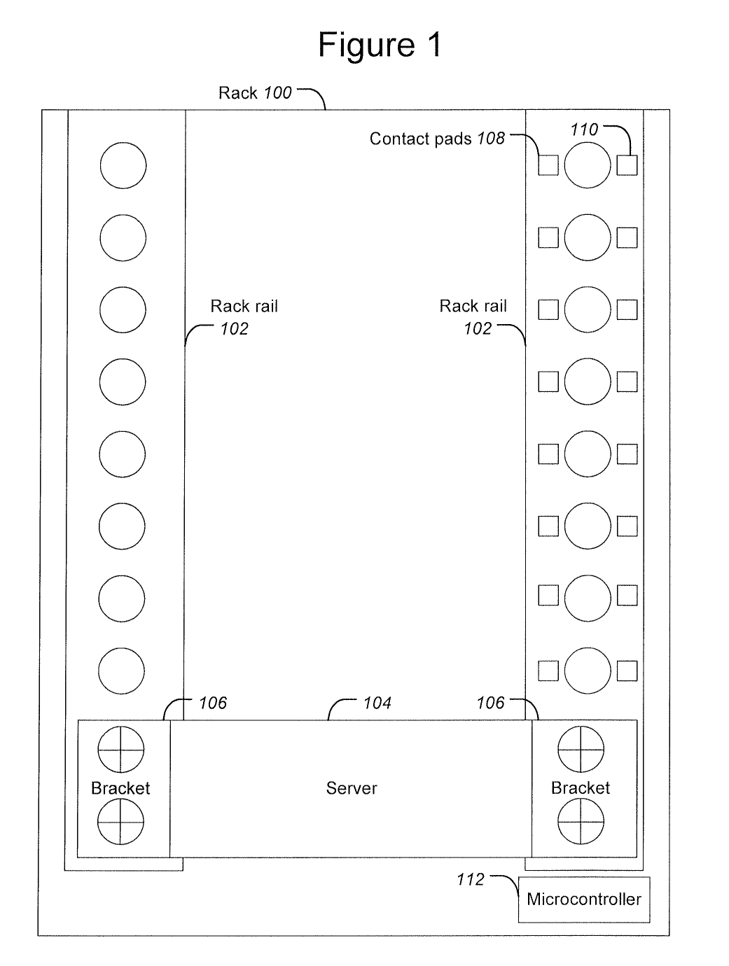

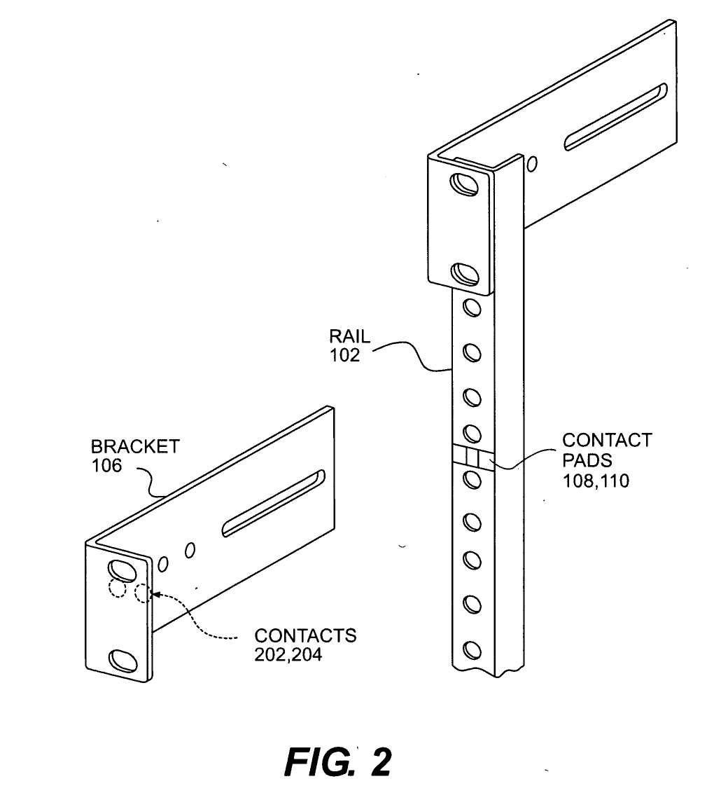

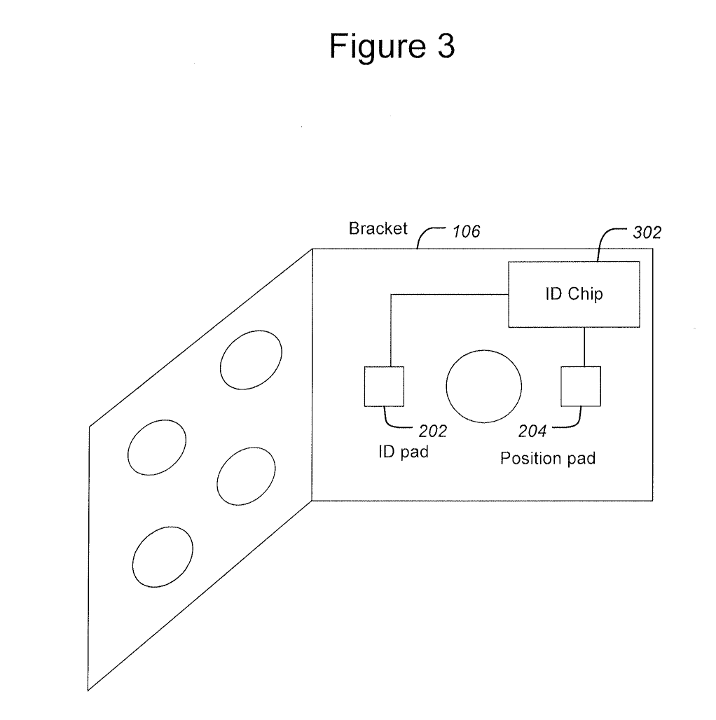

FIG. 1 depicts a rack 100 with two smart rails 102 storing a server 104 in accordance with methods and systems consistent with the present invention. Although not shown on the figure, many other servers or other IT components may be included in the slots on the rack or on other racks. In one implementation, the system includes three primary components: smart brackets 106 including ID chips, smart rack rails 102 including contact pads for interfacing with the ID chips on the smart bracket 106, and a microcontroller 112. Two spring-loaded contacts (shown on FIGS. 2 and 3) located on the smart brackets 106 are mated to two contact pads 108, 110 mounted on the smart rack rail 102 mounted on the rack 100. These contacts 108, 110 are used to send ID information in the bracket 106 identifying the presence of IT components (e.g., server 104), and to identify in which slots in the rack 100 the particular bracket 106 is mounted on. The detection and collection of the rack inventory is managed by the microcontroller 112 which interfaces with management appliance products (from Avocent, Inc., for example) through a network, such as a LAN, or a USB port. The equipment (e.g., brackets 106, rails 102, contacts 108, 110, microcontroller 112, etc.) may be mounted anywhere on the rack, slots or IT components, including the front or back. The equipment may be mounted vertically down the side of the rack 100, thereby reducing horizontal space consumed.

FIG. 2 illustrates a smart rack rail 102 and a smart bracket 106. As shown on the Figure, the smart bracket contacts 202, 204 mate with the contacts 108, 110 on the rail 102. In one implementation, the smart brackets 106 stay attached to the IT component equipment once they are attached. Appropriate security screws may be used to attach the smart bracket 106 to the equipment. In addition to smart brackets 106, self-adhesive mounting modules (ID chip and pads) may also be provided that attach to existing regular brackets.

FIG. 3 illustrates a diagram of a smart bracket 106 in accordance with methods and system consistent with the present invention. Each smart bracket 106 includes an ID chip 302 with a unique identification value (e.g., a number) may be tagged (bar-coded) for viewing on front of each bracket. Each ID chip 302 has an I/O pin (not shown) which is used to determine location as described below. Two separate pads (ID pad 202, position pad 204) on the smart bracket 106 are utilized to determine presence and position of the installed IT components as described below. To determine the presence of IT components, each smart bracket 106 has a passive ID chip 302 (for example, made by Maxim Integrated Products, Inc. (Maxim)) which allows access, in one implementation, through Maxim's proprietary 1-Wire interface. However, other types of ID chips 302 may be used. The Maxim protocol is used to scan the wire for the presence of each of these chips. Once the inventory of the IT components is completed, a periodic scan may be done to detect changes. The bracket will have the added ability (not shown) to store user information in a limited-sized persistent storage area.

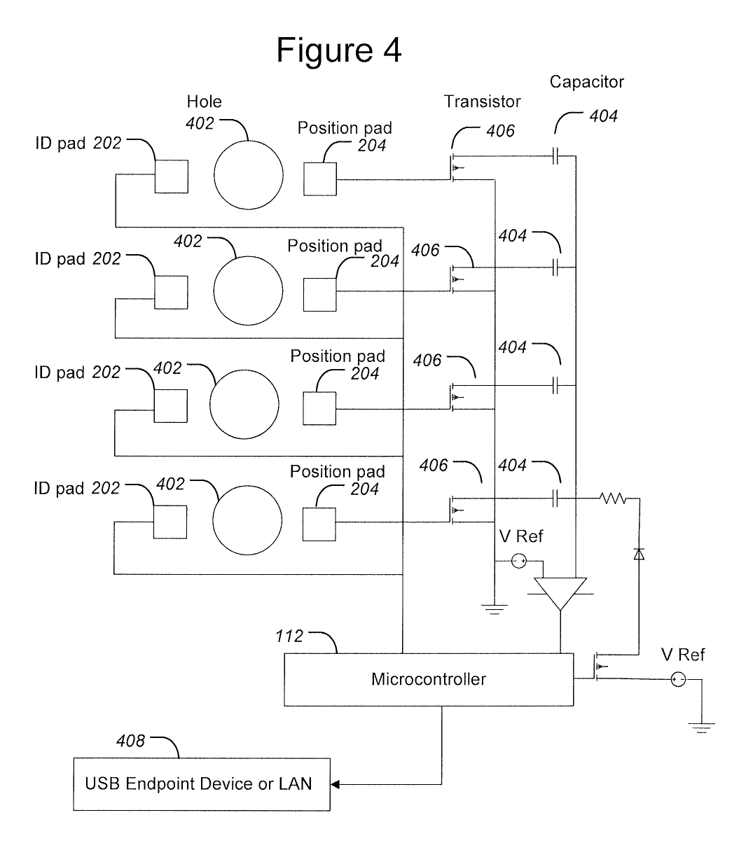

FIG. 4 illustrates a circuit diagram of a smart rail 102 having Id pads 202, position pads 204 and a microcontroller 112 in accordance with methods and system consistent with the present invention. When the system scans to check installed or removed IT components, a quick scan keeps inventory of IT components and issues alerts when a change occurs, such as an addition, removal or move of an IT component. The quick scan may use the Maxim protocol to scan for the present of the ID chips and hence the present IT components. The ID contact pads 202 are used to determine all of the IT components on the rack 100. Once a change is discovered, a more thorough and lengthy scan to detect position is initiated. To determine position of an IT component, each hole 402 or slot on the smart rack rail 102 has a position pad 108 and contact pad 110 and a transistor 406 and a capacitor 404. By varying the value of each capacitor 404 on the rail 102, and predetermining calibration of the values, a correlation can be made between the unique capacitor value and the slot position. In one implementation, the unique value is the capacitor's charge time. For example, a capacitor with a charge time of X milliseconds is located at slot 1, a capacitor with a charge time of Y milliseconds is located at slot 2, etc.

During the position scan (deep scan), to determine the position of an IT component, the microcontroller 112 individually turns on the I/O pin (not shown) of the ID chip 302 of the bracket 106 attached to that IT component. By turning on the I/O pin, the individual transistor 406 of the connected slot drives the associated capacitor 404 to ground. This assures that only the grounded capacitor 404 accepts the charge. The microcontroller 112 sends a charge pulse to the capacitors 404 through a resistor and charging begins. Then, the microcontroller 112 uses a voltage comparator (not shown) to detect the present charging voltage, and the charge time is measured. The system may determine that it took a certain amount of time to charge the capacitor 404, so it determines that the bracket 106 and IT component are in the slot that corresponds to that individual capacitor 404. Any of the brackets 106 may be tested in this manner. In one implementation, since each capacitor 404 has a unique value, and only 1 of 48 devices needs to be detected, for, example, there is enough resolution available to determine to which IT component and slot the capacitor 404 corresponds.

The microcontroller 112 manages scanning and communication with management devices/appliances. In one implementation, the microcontroller 112 may be a single chip mounted in any appropriate location on the rack. It may connect to a database or software layer through USB 408 (which can also be used to extract power) or over a network such as a LAN 408. In one implementation, the microcontroller 112 connects to the database through an intermediate software layer. This software layer may include data center management software, such as DSView from Avocent, Inc, which may allow access to various IT components and provide remote management and remote configuration. The microcontroller 112 may be connected to the DSView application through a network, or may be plugged into another appliance (e.g., via the USB or serial port of an Avocent console server or KVM system) which is connected to the DSView through the network. The DSView may pass the information received from the microcontroller 112 to the database or other application that manages the IT components of the data center. The microcontroller 112 provides an interface, via USB and an IP connection, enabling management appliances installed in the rack 100 or higher-level software applications, such as AMIE (Avocent MergePoint Infrastructure Explorer) or ALM (Asset Lifecycle Manager), to get access to rack inventory and change alerts. Other implementations are possible.

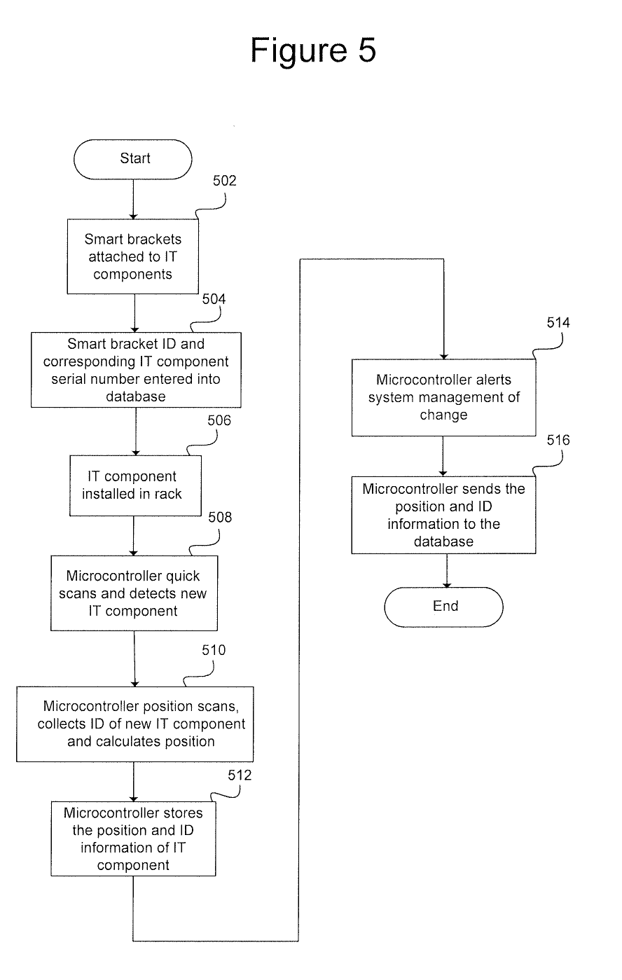

FIG. 5 depicts steps of an exemplary method for adding new IT components to a rack 100 in accordance with methods and systems consistent with the present invention. First, IT components for a data center arrive at a staging area. The equipment is provisioned (by, for example, preparing the equipment for operation by loading the operating system, applications, configuration and IP administration), and the smart brackets 106 are attached to the IT components such as server 104 (step 502). Next, the smart bracket ID is entered into the asset management database along with other pertinent information such as the corresponding serial number of the IT component (step 504). Then, the IT component is installed in the appropriate rack 100 and slot (step 506).

The microcontroller 112 in the instrumented rack 100 detects the addition of a new piece of equipment (during the quick scan process) (step 508). The microcontroller 112 performs a position scan of the rack 100), collects the ID of the smart bracket 106 attached to the new piece of equipment and calculates the position (slot numbers) of the IT components within the rack 100 using the capacitor detection process discussed previously (step 510). The position and presence information is stored in the microcontroller 112 (step 512). The microcontroller 112 sends an alert to the systems management software that the configuration of the rack 100 has changed (step 514). The systems management software connects to the microcontroller 112 and retrieves the information to update the database (step 516).

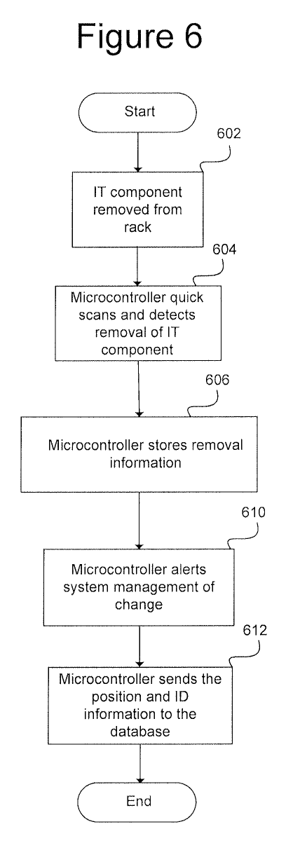

FIG. 6 depicts steps of an exemplary method for removing IT components from a rack 100 in accordance with methods and systems consistent with the present invention. First, an IT component is removed from the rack 100 (step 602). The microcontroller 112 in the instrumented rack 100 detects the removal of the equipment (in a quick scan) (step 604). The information is updated in the microcontroller 112 (step 606). The microcontroller 112 sends an alert to the systems management software that the configuration of the rack 100 has changed (step 608). The systems management software connects to the microcontroller 112 and retrieves the information (step 610) to update the database.

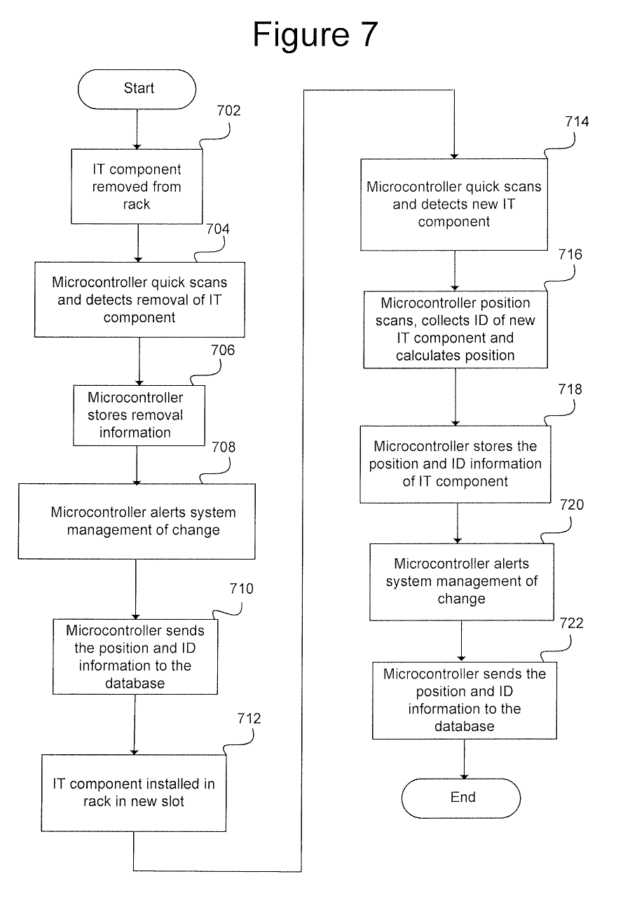

FIG. 7 depicts steps of a method for moving IT components in a rack 100 in accordance with methods and systems consistent with the present invention. First, an IT component is removed from a rack 100 (step 702). The microcontroller 112 in the instrumented rack 100 detects the removal of the equipment (during a quick scan) (step 704). The information is updated in the microcontroller 112 (step 706). The microcontroller 112 sends an alert to the systems management software that the configuration of the rack 100 has changed (step 708). The SMS connects to the microcontroller 112 and retrieves the information (step 710).

The IT component is then installed in a new slot location in the rack 100 (step 712). The microcontroller 112 in the instrumented rack 100 detects the addition of a newly located IT component (during a quick scan) (step 714). The microcontroller 112 then does a position scan of the rack 100, collects the ID of the smart bracket 106 attached to the new IT component and calculates the position (slot numbers) of the equipment within the rack 100 (step 716). The information is stored in the microcontroller 112 (step 718). The microcontroller 112 sends an alert to the systems management software that the configuration of the rack 100 has changed (step 720). The systems management software connects to the microcontroller 112 and retrieves the information (step 722) to update the database.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A method in a data processing system for automatically tracking locations of IT components, comprising:
attaching a bracket comprising an ID chip uniquely identifying the bracket to an IT component;
associating the bracket with the attached IT component;
inserting the IT component into a slot in a rack, the slot comprising one or more contacts configured to connect to the ID chip on the bracket;
automatically determining a presence of the bracket in the rack based on the ID chip; and
automatically determining a position of the bracket in the slot in the rack.

2. The method of claim 1, further comprising:
connecting a first ID contact on the bracket to a second ID contact on the slot; and
connecting and second position contact on the bracket to a second ID contact on the slot.

3. The method of claim 1, further comprising:
storing, in the database, identification and location information of IT components; and
updating the database upon receipt of the information regarding the presence of the bracket and position of the bracket.

4. The method of claim 1, further comprising:
scanning for the presence of the bracket; and
subsequently scanning for the position of the bracket.

5. The method of claim 1, wherein the slot includes a capacitor having a charge time uniquely identifying the slot; and
wherein the method further comprises charging the capacitor and measuring the charge time to uniquely identify the slot in which the capacitor is located.

6. The method of claim 1, wherein the IT component is one of: (1) a server, (2) a router, (3) a storage device appliance, (4) a PDU, (5) a Patch Panel PDU, (6) a UPS, and (7) a switch.

7. The method of claim 1, further comprising:
scanning for the presence of the bracket via ID contacts on the bracket and a rail on the rack; and
scanning for the position of the bracket via position contacts on the bracket and the rail on the rack.

8. The method of claim 7, wherein the scanning for the position of the bracket further comprises measuring the charge time of a capacitor on the rail to determine a slot in which the bracket is connected.

9. The method of claim 8, further comprising alerting the database when the IT component is removed from the rack.

10. The method of claim 9, alerting the database via one of: (1) a network and (2) a USB connection.

11. A data processing system for automatically tracking locations of IT components, comprising:
a bracket configured to attach to an IT component and comprising an ID chip uniquely identifying the IT component;
a rack comprising one or more slots, the slots configured to store an IT component and comprising one or more contacts configured to connect to the ID chip on the bracket; and
a microcontroller configured to:
determine a presence of the bracket and a position of the bracket in one of the slots when inserted into the slot; and
transmit information regarding the presence of the bracket and position of the bracket to a database.

12. The data processing system of claim 11, wherein the bracket further comprises a first ID contact and a first position contact; and
wherein the slot further comprises a second ID contact and a second position contact configured to connect to the first ID contact and first position contact on the bracket.

13. The data processing system of claim 11, wherein the database is configured to:
store identification and location information of IT components; and
update upon receipt of the information regarding one of: (1) the presence of the bracket and (2) the removal of the bracket, and information regarding the position of the bracket.

14. The data processing system of claim 11, wherein the microcontroller scans for the presence of the bracket, and subsequently scans for the position of the bracket.

15. The data processing system of claim 11, wherein the slot includes a capacitor having a charge time uniquely identifying the slot; and
wherein the microcontroller is configured to charge the capacitor and measure the charge time to uniquely identify the slot in which the capacitor is located.

16. The data processing system of claim 15, wherein the slot further comprises a capacitor having a charge time different from any other capacitor associated with any other slot in the rack.

17. The data processing system of claim 11, wherein the rack comprises a plurality of slots configured to store an IT component, each slot comprising a transistor, capacitor, ID contact pad and position contact pad.

18. The data processing system of claim 11, wherein the rack comprises one or more rails comprising one or more electronic components configured to uniquely identify one or more slots in the rack.

19. The data processing system of claim 11, wherein the IT component is one of: (1) a server, (2) a router, (3) a storage device appliance, (4) a PDU, (5) a Patch Panel PDU, (6) a UPS, and (7) a switch.

20. A data processing system for automatically tracking locations of IT components, comprising:
a bracket configured to attach to an IT component and comprising an ID chip uniquely identifying the IT component;
a rack comprising one or more slots, the slots configured to store an IT component and comprising one or more contacts configured to connect to the ID chip on the bracket wherein the slot includes a capacitor having a charge time uniquely identifying the slot; and
a microcontroller configured to:
determine a presence of the bracket in the rack;
determine a position of the bracket in one of the slots by charging the capacitor and measuring the charge time to uniquely identify the slot in which the capacitor is located; and
transmit information regarding the presence of the bracket and position of the bracket to a database,
wherein the database is configured to:
store identification and location information of IT components; and
update upon receipt of the information regarding the presence of the bracket and position of the bracket.
